(19) United States
(12) Patent Application Publication
(10) Pub. No.: US 2004/0085856 A1
(43) Pub. Date: May 6, 2004

(54) Mixer

(76) Inventor: James K. Murosako, Vancouver, WA (US)

Correspondence Address: Kathleen T. Petrich, Stokes Lawrence, P.S., Suite 4000, 800 Fifth Avenue, Seattle, WA, 98104-3179, US

(21) Appl. No.: 10/285,116

(22) Filed: Oct. 30, 2002

(51) Int. Cl. B01F 7/00; B01F 7/10; B01F 7/26

(52) U.S. Cl. 366/262; 366/316

(57) ABSTRACT

A mixer of fluids, such as paint or resins, having a shaft capable of rotating about a longitudinally-extending, centerline axis of the shaft and at least one rotor assembly that is fixedly connected to and axially-aligned of the shaft. The shaft rotates about its centerline axis as well as each rotor assembly. Each rotor assembly consists of a plurality of spaced apart rotors. Each rotor has substantially uniform upper and lower surfaces and generally smooth and uniform edges. In preferred form, each rotor is a smooth disk that may be flat, wavy, concave, convex, dimpled, or tilted in shape.

### TECHNICAL FIELD

The present invention relates generally to mixers, particularly, to mixers that mix fluids, such as paint, with little-to-no aeration or splash.

### BACKGROUND OF THE INVENTION

Conventional mixers in the paint industry, such as mixer 2 shown in the Prior Art FIG. 1, generally comprise a shaft (4)-driven impeller 6 (blades or rotors) that mixes fluids 10 (e.g. color pigments in a paint base) within a container 8 to achieve a fairly homogeneous mixture. However, conventional mixers splash (splash drops illustrated at numeral 12) so that these type mixers are run at lower speeds to reduce splashing. The drawback of the lower speeds is that manufacturing process times can be inefficient at high speeds. Also, air bubbles 14 are more likely to be introduced in the mixing process, which is wholly undesirable; and complete mixing may be sacrificed (incomplete mixing is illustrated at pockets 16).

Moreover, conventional mixers rotors retain coatings from the fluid mixture. When mixing is finished and the mixer is to be removed, the mixer must be stopped to avoid splashing or flinging the fluid coating outside the desired area.

For resin applications, such as resins used as coatings on fiberglass boats, bubbles are hand rolled out with pegs on a fiberglass cloth surface to which the resin is applied. The costly, labor-intensive process of rolling of the pegs over the resin surface breaks up the bubbles. If the bubbles are allowed to remain, the moisture in the bubbles will expand and contract with temperature variation. This expansion and contraction of the bubbles forces the glass laminate of fiberglass work surface to separate trapping moisture. The delamination of the fiberglass surface will ruin a boat hull, of which the repair is extremely expensive and keeps the product (boat) out of commission for an undesirable length of time.

### SUMMARY OF THE INVENTION

The present invention is directed to a new mixer for mixing fluids having a shaft with a proximal end and a distal end. The shaft is capable of rotating about a longitudinally-extending, centerline axis of the shaft. The mixer also includes at least one rotor assembly that is fixedly connected to and axially-aligned of the shaft such that when the shaft rotates about its centerline axis, each rotor assembly rotates about the shaft's centerline axis as well. Each rotor assembly consists of a plurality of spaced apart rotors. Each rotor assembly is defined by a most distal rotor relative to the shaft's proximal end and a most proximal rotor relative to the shaft's most proximal end. Each rotor has substantially uniform upper and lower surfaces and generally smooth and uniform edges.

There are many embodiments of the apparatus mixer of the present invention. In one embodiment, the distal rotor has no central opening and is directly connected to a distal end of the shaft. Yet at least one proximal rotor of the same rotor assembly includes a central opening through which the shaft is axially aligned. In use, fluid is pulled through the opening of the proximal rotor and exits through the space between the rotors.

In another embodiment, the distal rotor contains a central opening through which fluid is pulled and the most proximal rotor of the rotor assembly has no such opening and is directly attached to the shaft.

Other embodiments include the shape of the rotors, which may be flat, wavy, concave, convex, dimple, or tilted in shape. All rotors are preferably circular in shape as viewed from the top; however, other shapes such as balanced triangle, may be used.

In addition to various embodiments where the shaft may be positioned through each rotor assembly, there may be two or more adjacent mixers connected to a single shaft and power source.

The present invention also includes a method of mixing fluid with little-to-no aeration and little-to-no splash and no flinging of fluid when the mixer is removed from the fluid while the mixer is still rotating about the centerline axis. These and other features and benefits will be discussed in further detail below.

### BRIEF DESCRIPTION OF THE DRAWINGS

Like reference numerals are used to designate like parts through the several views of the drawings, wherein:

FIG. 1 is a perspective view of a Prior Art paint mixer shown mixing fluid (e.g. paint) within a container where air bubbles are created during mixing and splash is a by product;

FIG. 2 is a perspective view of the mixer of the present invention shown mixing fluid (e.g. paint) within a container like that illustrated in FIG. 1 except without air bubbles and splash;

FIG. 3 is a side perspective view of the mixer of the present invention along with a motor;

FIG. 4 is a section view taken substantially along lines 4-4 of FIG. 3;

FIG. 5 is an exploded view of the mixer of the present invention and better illustrating the spacers between the spaced-apart rotors;

FIG. 6 is an assembled side view of the motor-driven shaft and rotors;

FIG. 7 is an enlarged plan view of a single rotor of a second embodiment;

FIG. 8 is a section view taken substantially along lines 8-8 of FIG. 7;

FIG. 9 is a side elevational view of the mixer of the present invention illustrating fluid flow entering a substantially central opening through the top rotors;

FIG. 10 is a bottom plan view of FIG. 9;

FIG. 11 is a side elevational view of the second embodiment mixer illustrating fluid flow entering a substantially central opening through the bottom rotors;

FIG. 12 is a bottom plan view of FIG. 11;

FIG. 13 is a side elevational view of the third embodiment mixer and illustrating no generally central openings through which fluid could flow;

FIG. 14 is a bottom plan view of FIG. 13 and illustrating circular fluid flow paths within the space between the rotors;

FIG. 15 is a side elevational view of a fourth mixer embodiment including a plurality of generally concave-shaped curved rotors;

FIG. 16 is a side elevational view of a fifth mixer embodiment similar to FIG. 15 except that the rotors are generally convex in shape;

FIG. 17 is a top plan view of FIGS. 15 and 16;

FIG. 18 is a bottom plan view of FIGS. 15 and 16 and illustrating fluid flow paths within the space between the rotors;

FIG. 19 is a fragmentary front view illustrating a surface after painting with a paint mixed by a conventional mixer;

FIG. 20 is a side view of FIG. 19;

FIG. 21 is a fragmentary front view illustrating a surface after painting with a paint mixed by the mixer of the present invention;

FIG. 22 is a side view of FIG. 21;

FIG. 23 is a side elevational view of a sixth mixer embodiment illustrating two sets of rotors axially aligned of the same shaft;

FIG. 24 is a side elevational view of a seventh mixer embodiment like that of FIG. 23 but illustrating variations as to the number of rotors in a set;

FIG. 25 is a side elevational view of an eighth mixer embodiment;

FIG. 26 is a side elevational view of a ninth mixer embodiment;

FIG. 27 is a side elevational view of a tenth mixer embodiment;

FIG. 28 is a side elevational view of an eleventh mixer embodiment illustrating two mixers that are yoked together where the rotor blades of each mixer are aligned with the other mixer so that the two mixers can operate in unison;

FIG. 29 is a schematic side view of a twelfth mixer embodiment illustrating one rotor being tilted approximately 30 degrees relative to its adjacent rotors; and

FIG. 30 is a schematic side view of a thirteenth mixer embodiment illustration more than one rotor in a rotor assembly being tilted relative to adjacent rotors.

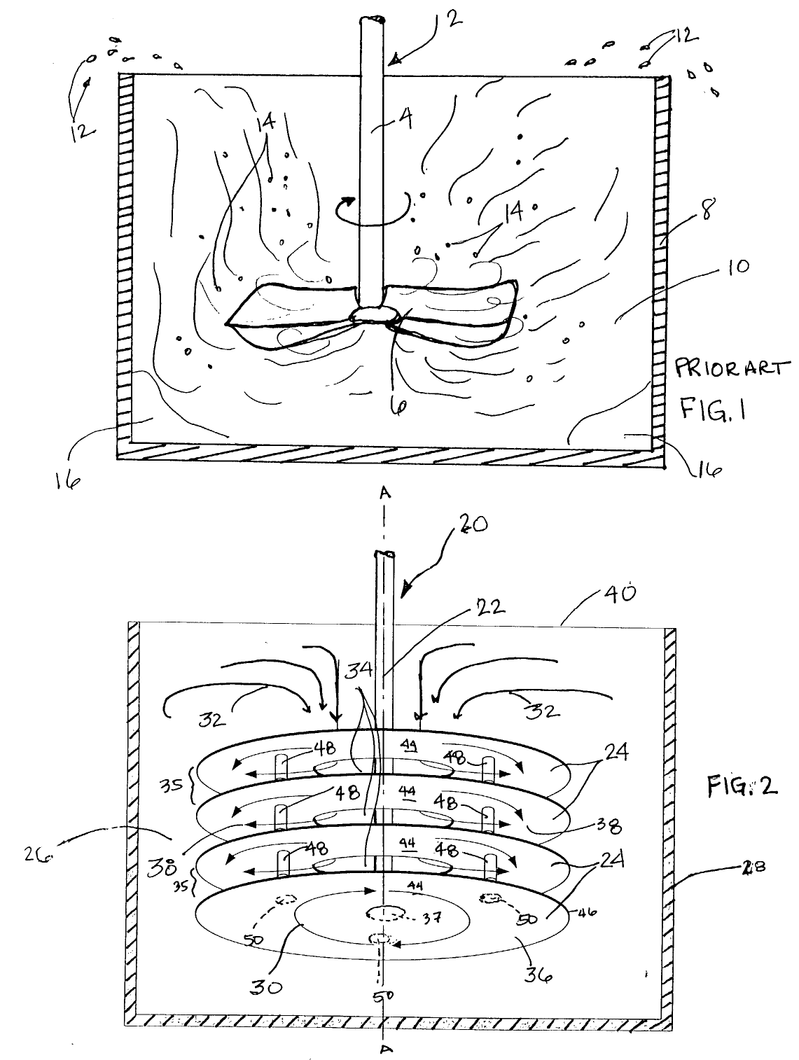

### BEST MODE FOR CARRYING OUT THE INVENTION

The present invention is directed to a new splash-less mixer that can be run at high speeds with little-to-no aeration (air bubbles). Such a mixer can have universal applications, e.g. marine propulsion, medical devices, pumps, power generation to name a few. But the advantages provided by splash-less, aeration-less mixing is particularly attractive to the paint industry or resin coating industry where aeration is wholly undesirable.

Referring to FIG. 2, the present invention mixer 20 consists of a shaft 22 and a plurality of spaced-apart rotors 24. Mixer 20 can be effectively used to mix a fluid 26 (e.g. paint) within a container 28. A torque, which may be clockwise or counterclockwise in direction, is applied to the shaft 22 (such as by motor shown at 29) to rotate shaft 22 about axis A-A. For illustrative purposes, the torque is shown applied in a clockwise motion as indicated by arrow 30. Fluid (generally indicated at 32) near the upper or proximal rotors is sucked into generally centrally located openings 34 within the rotors 24 save for the most distal rotor 36, in which shaft 22 is physically connect such as by a weld 37, as illustrated. Shaft 22 is also positioned within and axially aligned with the each of the openings 34 of the rotors such that fluid 32 above the upper or proximal rotors enters the openings 34 about the shaft 22 and exits through the space 35 between the rotors 24 in a fluid flow illustrated as 38. The net effect is that the mixer creates a whirlpool-like effect within the fluid mixture, the fluid does not splash over the fluid line 40, little to no air bubbles are created, and all fluid is mixed.

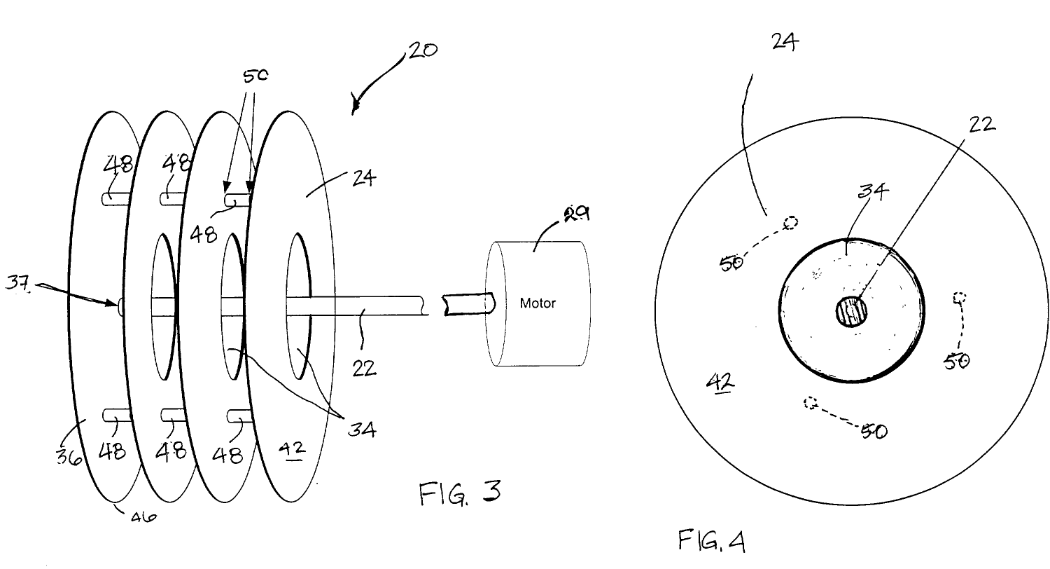

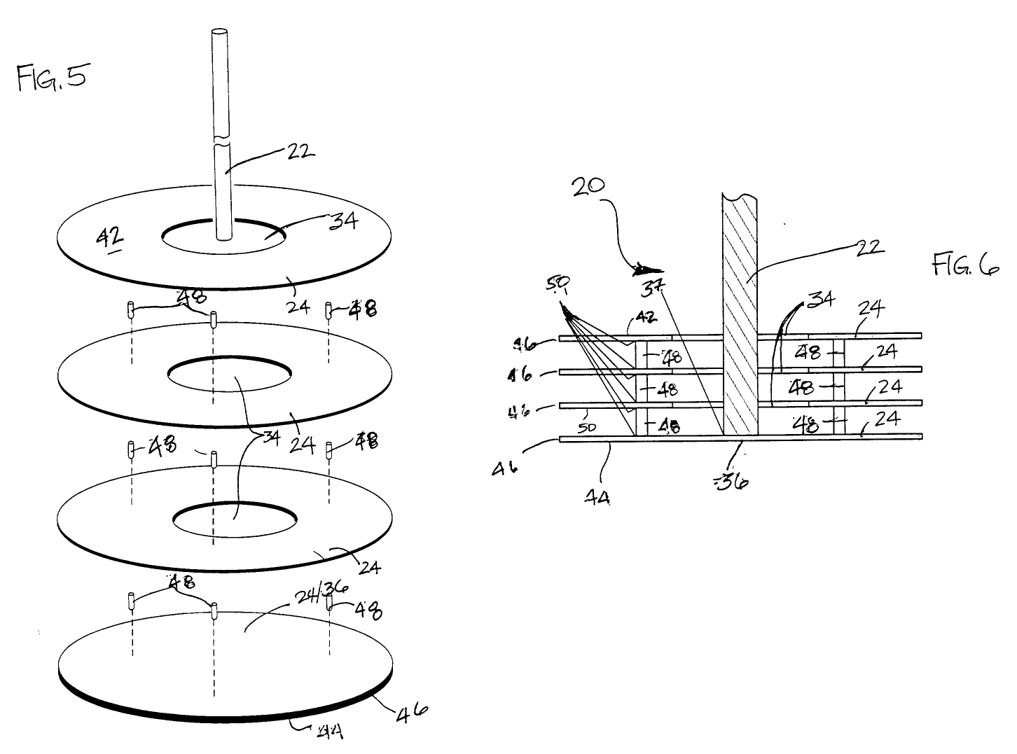

Referring also to FIGS. 3-6, each rotor is substantially the same size and shape and has a substantially smooth top surface 42 and a substantially smooth bottom surface 44 with a substantially smooth outer edge 46. Each rotor 24 is preferably substantially circular in shape as viewed from the top; however, other shapes may be used, such as a balanced triangle (not shown). And in a first rotor embodiment, each rotor has flat upper and lower surfaces 42, 44. Although many materials may be used, in preferred form, each rotor may be made from high carbon steel or aluminum with a titanium nitride surface coating. Alternatively, the rotors may be made from man-made materials such as polymers. Depending on the application, the rotor size will vary. For illustrative purposes, however, a rotor having a four inch diameter may have a thickness of approximately 0.030 inches with a central opening of 1.5 inches and a shaft diameter of 0.375 inches.

In use, as each rotor rotates about the centerline axis of the shaft, a boundary layer develops between the rotor and the fluid medium. Adhesion between the disk surface and the fluid medium causes the medium to be “pulled along” in the direction of rotation of the rotor. Because the medium has mass, it is thrown out along the radius of the rotor in a very aggressive manner in a path that curves in the direction of rotation of the rotor. This causes convection, which results in the mixing action. As the rotor rotates about the centerline axis, the rotation also causes vortices at the edge of the rotor, not unlike the vortices created on the wingtip of an airplane as the edge passes through air. The vortices also creates a mixing action in addition to the centrifugal action. And all of these actions are non-cavitating.

Although four rotors have been tested with good results, it is not necessary to have four rotors as illustrated. Rather, the number of rotors will be dependent on the overall viscosity of the fluid, the size of the rotors, the size of the motor, and the amount of the fluid that is to be mixed. Thus, some applications may only require two or three, rotors, and some applications may require six or more spaced apart rotors.

Moreover, the rotors need not be equally spaced apart as illustrated. Rather, there needs to be sufficient space between the rotors to effectively mix the fluid, which is dependent on at least the factors listed in the paragraph above. For the example of the 4 inch diameter rotor given above, the space gaps between the rotors may range from 0.120 inches to 0.375 inches. However, the space is dictated by the application and size of the rotors, shaft size, and viscosity of the fluid, amongst other factors. One of ordinary skill in the art will appreciate that many variations of the rotor size and space gaps are encompassed by the present invention.

Although the rotors may be spaced apart by a variety of means, in the best mode each rotor is spaced apart by a plurality of spacers 48 (three are illustrated), which may be welded to the rotors by welds 50. In this manner, rotors 24 having central openings through which the shaft is axial aligned may still be fixedly connected to the shaft even if each rotor is not directly connected to the shaft.

Referring to FIGS. 7 and 8, a second rotor embodiment 24′ is shown. Rotor 24′ may have a dimpled or wavy overall shape 52 as can best be seen in section view FIG. 8. Although many variations of the dimpled rotor are incorporated into the present invention, one version of the wavy rotor has three panels 54 in which the wave 52 or dimple is substantially equally spaced apart on the rotor 24 to maintain stability at high speeds. Another option is to include a slightly textured outer surface 42′ with the addition of micro dimples 56 over some or all of the outer surface (FIG. 7 illustrates only a portion of outer surface 42′ with micro dimples 56). The micro dimples create turbulence between the rotors during mixing, but without the formation of large air bubbles. A micro dimple is generally smaller than a head of a pin, where a bubble is generally anything larger than the size of a pin head.

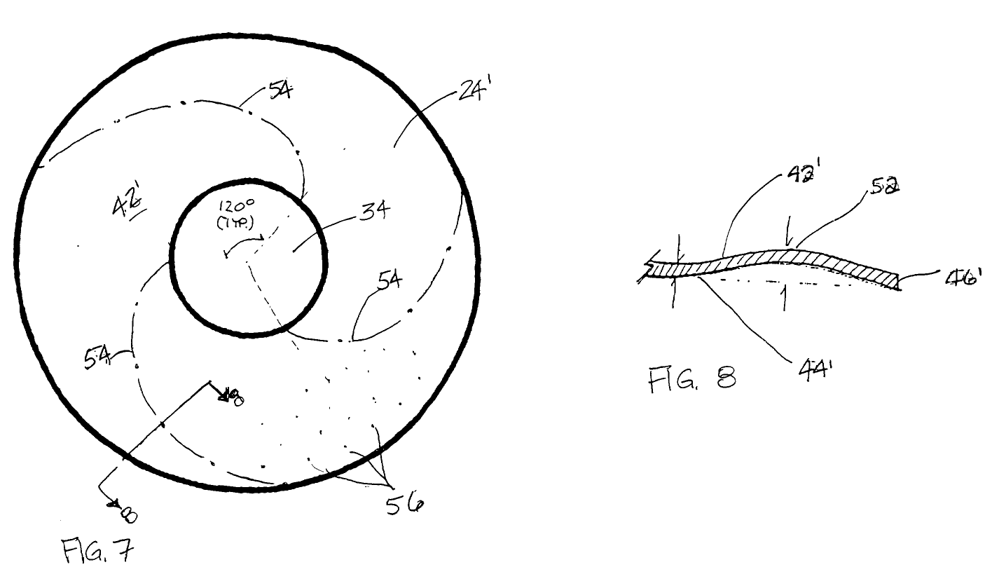

Referring to FIGS. 9-14, variations on the placement or lack of the central opening 34 provides different fluid flow for different applications. The embodiment of FIGS. 9 and 10 is a side view and bottom view of the mixer 20 already discussed above. Fluid 32 is pulled into opening 34 and the “folding” of the fluid is within the opening where some bubble formation can occur. The distal rotor 36 contains no opening and is connected directly to the distal end of the shaft. The mixed fluid is forced out through the space gaps 35 between the rotors 24 in a fluid flow path illustrated at numeral 38. This application is well-suited for paints and grouts.

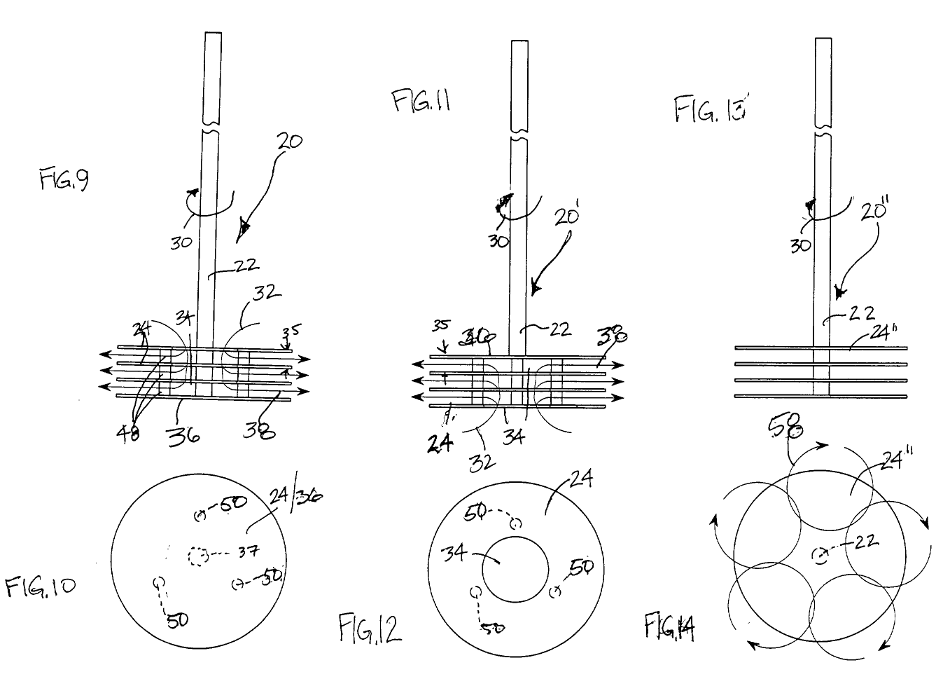

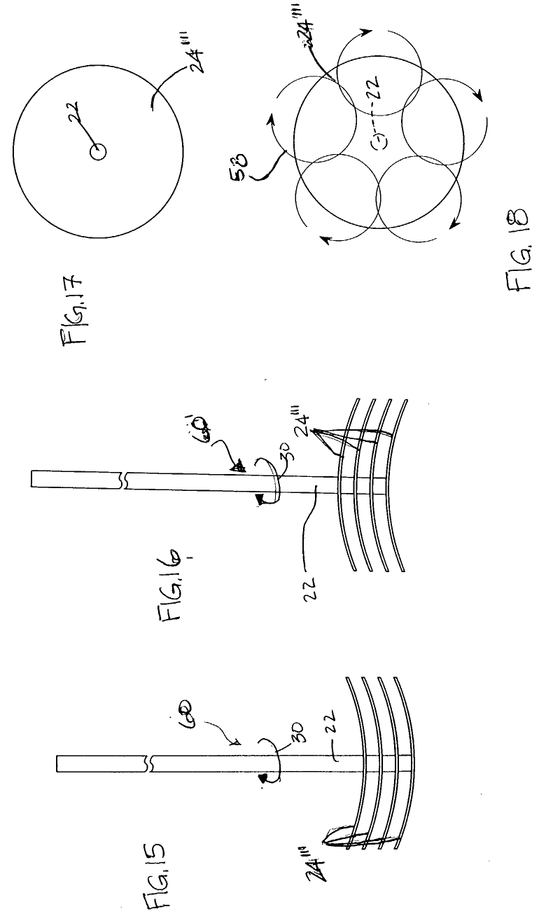

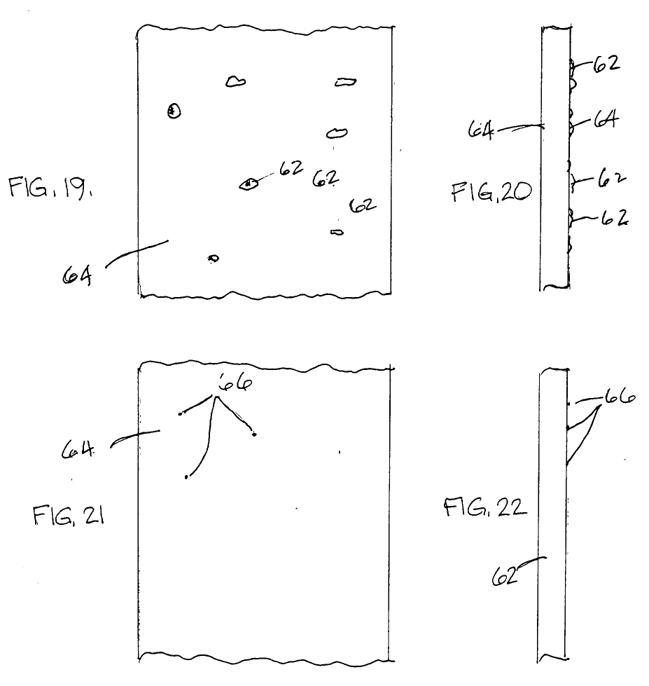

A different fluid flow path is created when the most proximal rotor (or top rotor) contains no opening, but the most distal rotor (or bottom rotor) does contain a generally central opening 34 as illustrated in FIGS. 11 and 12. Here, the fluid is pulled into the bottom of the mixer and out through the space gaps 35 between the rotors 24, which has a reverse fluid flow of the mixer embodiment of FIG. 9. In this embodiment, no “hole” or opening for fold over at high speeds exists. The upper rotors vortices create no aeration. This embodiment, like the embodiment of FIGS. 9 and 10, can be used at high speeds. Another embodiment mixer is shown in FIGS. 13 and 14 in which neither the most proximal or the most distal rotor contains generally central opening 34. Rather, all of the rotors are directly attached to shaft 22. Vortices at the rotor edges cause mixing with reverse laminar flow in the fluid, which is illustrated by numeral 58 within the space gaps 35 between the rotors. There is no opportunity for the air to enter mixed fluids. This embodiment is well suited for resins and polyurethanes. However, the speed of mixing may be slower than the embodiments of FIGS. 9-12.

Similar to the wavy rotor of FIGS. 7 and 8, mixer 60 and 60′ may also include rotors 24′″with a general overall concave (FIG. 15) or convex (FIG. 16) shape. The benefit of the concave/convex rotors is the introduction of more aggressive and turbulent laminar flow exiting the rotor space.

Referring to FIGS. 19-22, as discussed in the Background of the Invention, air bubbles 62 created during mixing can be present on the surface 64 to which the mixed fluid (e.g. paint) is applied and illustrated in FIGS. 19 and 20. This is wholly undesirable. Mixing fluids by the mixer (and its various embodiments) of the present invention is virtually done without aeration, as evidenced by the few and small pin hole sized disturbances 66 (shown enlarged for clarity) on surface 64 relative to the air bubbles shown in FIGS. 21 and 22.

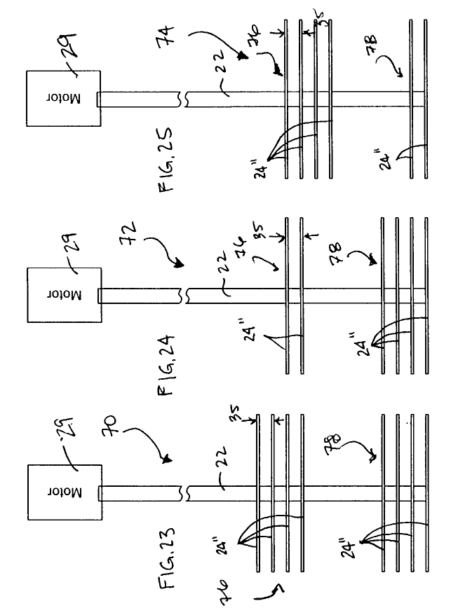

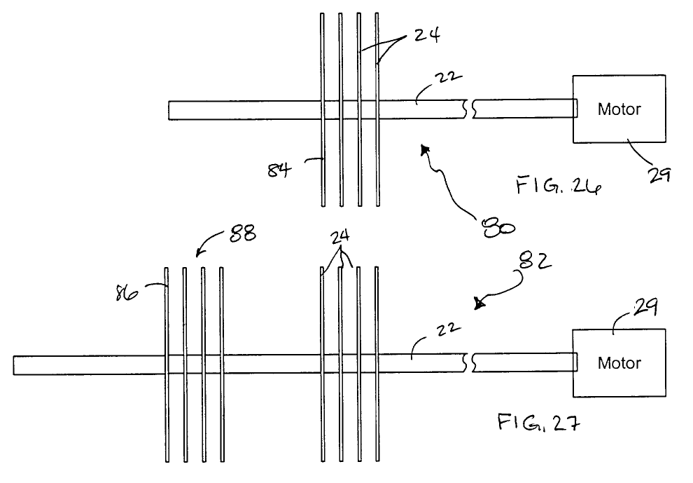

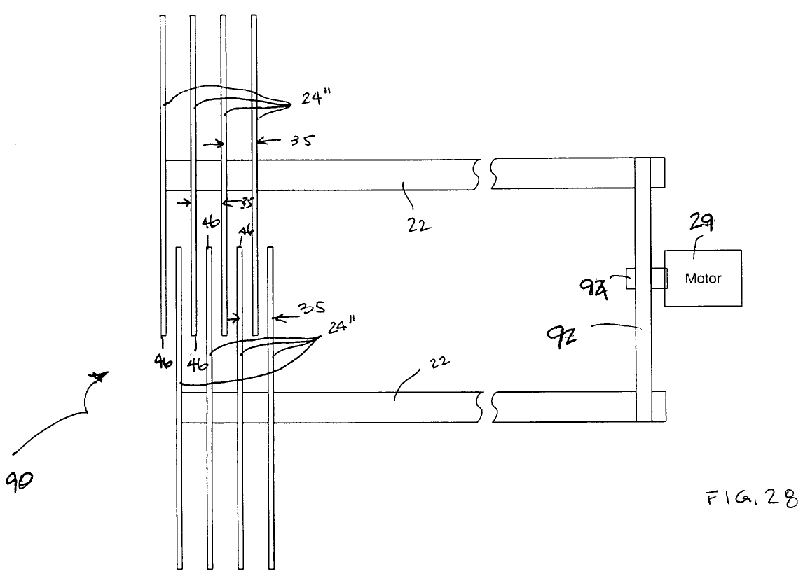

FIGS. 23-25 illustrate additional embodiments of the mixer of the present invention. For example, mixers 70, 72, and 74 may have two sets of rotors 76 and 78 connected to and rotated by the same shaft 22. This application may be particularly useful for large volumes of fluid mixing, slow speed applications (such as resin mixing applications), or highly viscous fluid mixing, or for mixing a range of fluid viscosities. Additionally, a rotor set may comprise differing numbers of individual rotors depending on the application (two to four rotors per set are illustrated).

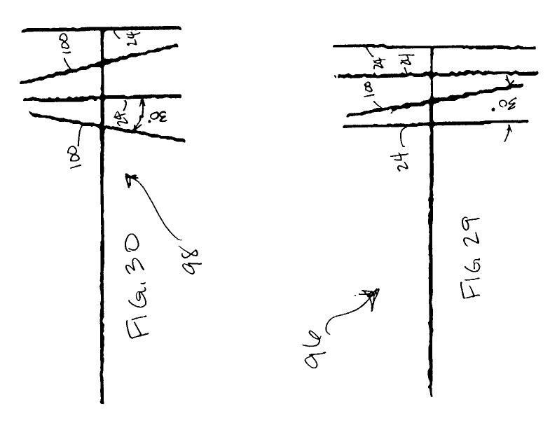

Moreover, the shaft does not need to terminate at the end of the distal rotor, as illustrated by mixer embodiments 80 and 82 in FIGS. 26 and 27, respectively. Rather, depending on the mixing application, such as mixing fluid in a long tube, shaft 22 may extend well past the most distal rotor 84 individually or the most distal rotor 86 of a rotor set 88. The present invention may also include synchronized mixers 90 that are yoked or other otherwise conjoined by yoke or mantle 92 to a common shaft 94 such as the mixer illustrated in FIG. 28. The rotors may be coplanar to each other with the outer edges of each rotor intertwined with the space gaps 35 of the adjacent mixer Referring to FIGS. 29 and 30, alternate mixer embodiments 96, 98 respectively, are shown schematically in which each mixer includes a tilted rotor 100 relative to adjacent rotors 24. In the embodiment illustrated in FIG. 29, the tilted rotor is at a 30 degree angle from horizontal. The embodiment illustrated in FIG. 30 illustrates two tilted rotors each at 30 degrees, although the number of degrees is not the important criteria. The tilt causes a modification in the boundary layer between the disks that result in a more turbulent exit of mixed medium. These embodiments are particularly useful in more viscous mediums, like grouts where a folding action in the fluid is needed to achieve a homogeneous mix.

The present invention is designed to mix at much higher speeds than conventional mixers. For example, the mixers are designed to rotate at up to approximately 25,000 rpm. A motor that can handle this type of application might be a brushless dc motor. However, the present invention mixer may also function suitably at lower speeds, such as 500 rpm. And the present invention may be suitably used for mixing conventional gallon paint containers using a hand-held drill motor as the power source.

The mixer of the present invention has many advantages over the prior art. Beyond the advantages discussed above, namely thorough mixing with little-to-no aeration or splash, the mixer of the present invention can be run at a higher rate of speed (e.g. at least 50% faster) than conventional mixers, less torque, ergo less energy, is required to run the mixer of the present invention, it is easier to clean as fluid does not substantially touch the rotor surfaces during mixing, there are fewer surfaces for fluid to adhere, and the life of the mixer is anticipated to be many time longer than conventional mixers as the there will be significantly reduced coating buildup. Moreover, the mixer of the present invention can be run both clockwise and counterclockwise and is inherently stable, thus, making the mixer easier to use for mixing fluids.

Another benefit of the present invention is that because fluid coating on the rotors is reduced, the mixer does not need to be stopped before removing the mixer from the fluid container. Thus, the mixer of the present invention increases efficiency and speed

The illustrated embodiments are only examples of the present invention and, therefore, are non-limitive. It is to be understood that many changes in the particular structure, materials, and features of the invention may be made without departing from the spirit and scope of the invention. Therefore, it is the Applicant's intention that his patent rights not be limited by the particular embodiments illustrated and described herein, but rather by the following claims interpreted according to accepted doctrines of claim interpretation, including the Doctrine of Equivalents and Reversal of Parts.

What is claimed is:

1. A mixer of fluids comprising:
a shaft having a proximal end and a distal end, said shaft being capable of rotating about a longitudinally-extending, centerline axis of the shaft;
at least one rotor assembly fixedly connected to and axially-aligned of the shaft such that when the shaft rotates about its centerline axis, the at least one rotor assembly rotates about the shaft's centerline axis; said at least one rotor assembly consisting of a plurality of spaced apart rotors, wherein each said rotor assembly is defined by a most distal rotor relative to the shaft's proximal end and a most proximal rotor relative to the shaft's most proximal end; and
each said rotor having substantially uniform upper and lower surfaces and generally smooth and uniform edges.

2. The mixer according to claim 1 wherein at least the proximal rotor in the rotor assembly includes a central opening through which the shaft is axial aligned and wherein at least the distal rotor in the rotor assembly has no central opening and is connected directly to the distal end of the shaft.

3. The mixer according to claim 1 wherein at least the distal rotor in the rotor assembly includes a central opening through which the shaft is axial aligned and wherein at least the proximal rotor in the rotor assembly has no central opening and is connected directly to the shaft.

4. The mixer according to claim 1 wherein the distal end of the shaft is directly connected to the distal rotor of the most distal rotor assembly.

5. The mixer according to claim 1 wherein there are two sets of rotor assemblies.

6. The mixer according to claim 1 wherein there are four rotors in each rotor assembly.

7. The mixer according to claim 2 wherein there are four rotors in each rotor assembly.

8. The mixer according to claim 1 wherein each rotor is equidistant from the adjacent rotor in the same rotor assembly.

9. The mixer according to claim 1 wherein each rotor is a flat disk.

10. The mixer according to claim 1 wherein each rotor surface is smooth.

11. The mixer according to claim 9 wherein each rotor surface is smooth.

12. The mixer according to claim 8 wherein each rotor is a flat disk.

13. The mixer according to claim 1 wherein each rotor is wavy in shape.

14. The mixer according to claim 8 wherein each rotor is wavy in shape.

15. The mixer according to claim 1 wherein each rotor has a substantially circular shape as viewed from the top.

16. The mixer according to claim 15 wherein each rotor is a flat disk.

17. The mixer according to claim 15 wherein each rotor has a wavy shape.

18. The mixer according to claim 13 wherein each rotor has at least a portion of its surface dimpled.

19. The mixer according to claim 1 wherein one or more rotors may be tilted relative to adjacent rotors.

20. A mixer of fluids comprising:
at least two adjoined shafts, each shaft having a proximal end and a distal end, said shaft being capable of rotating about a longitudinally-extending, centerline axis of the shaft; and
at least one rotor assembly fixedly connected to and axially-aligned of each shaft such that when each shaft rotates about its centerline axis, each shaft's at least one rotor assembly rotates about its respective shaft's centerline axis; said at least one rotor assembly consisting of a plurality of spaced apart rotors, wherein each said rotor assembly is defined by a most distal rotor relative to the shaft's proximal end and a most proximal rotor relative to the shaft's most proximal end, and wherein the rotors of the of rotor assembly of each shaft rotate in the space created by the spaced-apart rotors of the adjacent rotor assembly.

21. A method of mixing a fluid body with little to no aeration and little to no splash comprising:
providing a shaft having a proximal end and a distal end, said shaft being capable of rotating about a longitudinally-extending, centerline axis of the shaft;
and providing at least one rotor assembly fixedly connected to and axially-aligned of the shaft such that when the shaft rotates about its centerline axis, the at least one rotor assembly rotates about the shaft's centerline axis; said at least one rotor assembly consisting of a plurality of spaced apart rotors, wherein each said rotor assembly is defined by a most distal rotor relative to the shaft's proximal end and a most proximal rotor relative to the shaft's most proximal end;
positioning the mixer within a body of fluids such that the rotor assembly is within the fluid body; and
applying a torque to the shaft so that the shaft and rotors of the rotor assembly spin about the centerline axis of the shaft thereby mixing the fluids.

22. The method according to claim 21 wherein at least the proximal rotor in the rotor assembly includes a central opening through which the shaft is axial aligned and wherein at least the distal rotor in the rotor assembly has no central opening and is connected directly to the distal end of the shaft such that fluid is pulled into the central opening of the proximal rotor during mixing and out through the space between the spaced apart rotors.

23. The method according to claim 21 wherein at least the distal rotor in the rotor assembly includes a central opening through which the shaft is axial aligned and wherein at least the proximal rotor in the rotor assembly has no central opening and is connected directly to the shaft such that fluid is pulled into the central opening of the distal rotor during mixing and out through space between the spaced apart rotors.
